(19) United States
(12) Patent Application Publication
(10) Pub. No.: US 2011/0044771 A1
(43) Pub. Date: Feb. 24, 2011

(54) FLEXIBLE STABILIZING STRIP INTENDED TO BE USED IN REINFORCED SOIL CONSTRUCTIONS

(75) Inventors: Nicolas Freitag, Orsay (FR); Jean-Claude Morizot, Paris (FR)

Correspondence Address: MCKENNA LONG & ALDRIDGE LLP, 1900 K STREET, NW, WASHINGTON, DC, 20006, US

(73) Assignee: TERRE ARMEE INTERNATIONALE, Velizy Villacoublay (FR)

(21) Appl. No.: 12/921,019

(22) PCT Filed: Feb. 16, 2009
(86) PCT No.: PCT/EP09/51812

§ 371 Date: Nov. 1, 2010

(30) Foreign Application Priority Data
Mar. 4, 2008 (FR) 08 51407

(51) Int. Cl. E02D 5/00; E02D 3/00; E02D 7/00; B29C 47/00; B29C 70/58

(52) U.S. Cl. 405/302.7; 405/302.4; 242/160.4; 264/138

(57) ABSTRACT

Flexible stabilizing strip (10) of substantially constant thickness e, intended to be used in reinforced soil constructions, which comprises a central portion (100) essentially consisting of a fibre-reinforced polymer matrix, the said portion running longitudinally in order to withstand tensile forces, and at least one variable-width lateral portion (105) comprising a plurality of segments (110, 120, 130) arranged in a continuity of material along the central portion (100). Associated construction. Methods of manufacturing such a strip.

The present invention relates to a flexible stabilizing strip intended to be used in reinforced soil constructions, and the use of a strip such as this for building reinforced soil constructions.

A reinforced soil construction combines a compacted backfill, a facing, and reinforcements that may or may not be connected to the facing.

There are various types of reinforcement that may be used: rigid metal strips, for example made of galvanized steel, flexible stabilizing strips for example based on polyester fibres. These are positioned in the soil at a density that is dependent on the stresses liable to be applied to the construction, the thrust of the land being reacted by friction between the soil and the reinforcements.

The facing is usually made of prefabricated concrete elements, in the form of slabs or blocks, which are juxtaposed to cover the frontal face of the construction.

The flexible strips are often supplied in the form of strips about 3 to 10 metres long, although shorter or longer strips may be used. The width of the strips generally ranges between 4 and 6 centimetres although it is possible to use strips of a width ranging as high as 10 or 25 centimetres or even more. Their thickness varies, for example, from about 1 millimetre to a few centimetres and generally ranges between 1 and 6 millimetres.

The purpose of the stabilizing strips is to transmit the forces through the soil or the earth and thus distribute load.

In particular, it is necessary to transmit force between a strip and the backfill in which it is laid. The strip therefore has to have enough surface area that friction is able to develop the required shear strength per unit length.

Further, and for preference, the strip is capable of transmitting load over its entire length and therefore has good tensile strength.

Solutions have been proposed with a view to increasing the friction between a reinforcement and the soil in order in particular to reduce the number of reinforcements needed to consolidate a construction and/or to increase the strength of a construction.

Patent document FR 2 325 778 discloses metal reinforcements in which successive ribs increase the coefficient of friction between the soil and the reinforcements.

Patent document EP 0 818 577 discloses flexible reinforcements in which an elongate but not flat core element is surrounded by retaining nodules that project from the core.

These solutions, although they do increase the coefficient of friction between soil and reinforcements, have certain disadvantages. Specifically, the reinforcements thus proposed are somewhat awkward to handle and the presence of protruding elements means they have to be transported flat. They are also difficult to stack.

It is an object of the present invention to propose a solution which, while offering a reinforcement in which the coefficient of friction between the soil and the reinforcements is improved, allows for ease of handling.

The invention thus proposes a flexible stabilizing strip of substantially constant thickness e, intended to be used in reinforced soil constructions, and comprising a central portion running longitudinally in order to withstand tensile forces, and at least one variable-width lateral portion comprising a plurality of segments arranged in a continuity of material along the central portion.

Advantageously, the stabilizing strip according to the invention can be rolled up, thus making it easier to store, transport and install, for example by unrolling the said stabilizing strip on site, when it needs to be laid on some backfill material.

In the context of the present invention, a “central portion that runs longitudinally to withstand tensile forces” is to be understood to mean a portion of a stabilizing strip which runs in the lengthwise direction, along the longitudinal axis of the said strip. This portion is in continuity of material along the entire length of the said strip so as to be able to withstand tensile forces. For preference, the width of the said portion is substantially constant over the entire length of the said strip.

A “lateral portion” is to be understood to mean a portion of a stabilizing strip that lies on one and/or the other side of the central portion that runs longitudinally to withstand tensile forces.

A lateral portion according to the invention such as this is of variable width and comprises a plurality of segments. The segments may be positioned along the entire length of the central portion for withstanding tensile forces, or along just part of this portion. The variation in width of the lateral portion is at least due to the presence of said segments, but it is conceivable for other parts of a lateral portion to be of variable width.

It goes without saying that the idea of width relates to a distance along an axis perpendicular to the longitudinal axis and to an axis through the thickness of the strip.

A “substantially constant thickness” is to be understood to mean a thickness that varies very little over the entire width and over the entire length of the stabilizing strip. Minimal variations in thickness may, however, arise as a result of fluctuations in process parameters, for example during extrusion.

“Segments” are to be understood to mean portions of materials arranged in continuity of material along the portion for withstanding tensile forces, in which the width of the lateral portion is zero at least at some point between two consecutive segments of the said lateral portion. As a result, the width of the lateral portion varies between 0 and the maximum width of the segments in those regions of the lateral portion that have segments.

The segments may have numerous shapes. In general, the segments have at least an outline in the form of a straight part parallel to the longitudinal axis. For preference, two consecutive straight parts are spaced apart by a length at least equal to their own length.

The segments may be of constant width, namely they may be squares or rectangles, or they may be of variable width.

For preference, the segments are uniformly distributed along the longitudinal axis, in particular all along the longitudinal axis of the flexible reinforcing strip.

However, a flexible reinforcing strip may comprise two parts, one with lateral segments and the other, of constant width l, with no lateral segments.

A flexible stabilizing strip according to the invention may also have one or more of the following optional features, considered individually or in any feasible combination:

the central portion essentially consists of a fibre-reinforced polymer matrix;

the variable-width lateral portion contains no fibres;

a variable-width lateral portion lies on each side of the portion for withstanding tensile forces;

each segment of the variable-width lateral portion has a maximum width less than or equal to the width of the portion for withstanding tensile forces;

the variable-width lateral portion segments are in the shape of a parallelepiped, for example of a trapezium;

the variable-width lateral portion segments have a triangular shape;

the variable-width lateral portion segments have a shape comprising curved parts that connect the tensile-force-withstanding central portion to straight parts that are parallel to the said central portion;

the variable-width lateral portion segments extend over 20 to 80% of the length of the central portion.

The invention is also aimed at a reel of flexible stabilizing strip comprising a core around which flexible stabilizing strip according to the invention is wound.

The invention also relates to a method of manufacturing a flexible stabilizing strip, in which a flexible strip of substantially constant thickness and width, particularly one obtained by extrusion, is sourced, and in which segments of material are cut away at least along one longitudinal edge to form a plurality of segments.

According to another embodiment, an extrudable material is extruded through an extrusion head in substantially the shape of a rectangle of which the shortest dimension corresponds to the desired thickness of the flexible stabilizing strip and the longest dimension can vary so as to vary the cross section of the said extrusion head during extrusion in order to form a plurality of segments.

According to another embodiment, an extrudable material is extruded through an extrusion head in substantially the shape of a rectangle of which the shortest dimension corresponds to the desired thickness of the flexible stabilizing strip and the longest dimension corresponds to its maximum width, and the said extrusion head is moved back and forth in the direction of its longest dimension during the extrusion in order to form plurality of segments.

According to another embodiment, an extrudable material is extruded through an extrusion head in substantially the shape of a rectangle of which the shortest dimension corresponds to the desired thickness of the flexible stabilizing strip and the longest dimension corresponds to its maximum width, and the material thus extruded passes through a sizing jig in substantially the shape of a rectangle of which the shortest dimension corresponds to the desired thickness of the flexible stabilizing strip and the longest dimension corresponds to its maximum width and the said sizing jig is moved back and forth in the direction of the longest dimension as the extruded material passes through the sizing jig so as to form a plurality of segments.

According to another embodiment, an extrudable material is extruded through an extrusion head in substantially the shape of a rectangle of which the shortest dimension corresponds to the desired thickness of the flexible stabilizing strip and the longest dimension corresponds to its central portion width and lateral segments are attached, for example by stitching, welding or bonding.

According to another embodiment, an extrudable material is extruded to form the central portion of the reinforcing strip that is then placed in a mould, in which extrudable material is added in such a way as to form and attach, for example by welding, the lateral segments.

The extrudable material may be a polymer matrix into which continuous fibres are inserted, in which the said continuous fibres are kept under tension during the extrusion process in order to reinforce that portion of the flexible stabilizing strip that runs longitudinally so as to withstand tensile forces.

The invention also relates to a reinforced soil construction comprising at least one stabilizing strip according to the invention.

A further subject of the invention is a method of building a reinforced soil construction in which a facing is laid across a frontal face of the construction, delimiting a volume that is to be back-filled, reinforcements are positioned in a region of the said volume, backfill material is brought into the said volume and the back-fill material is compacted, in which the said reinforcements comprise at least one stabilizing strip according to the invention.

According to one embodiment, the step in which the reinforcements are positioned comprises a step of unrolling the said reinforcements from a reel.

The invention will be better understood from reading the description which will follow, given solely by way of example made with reference to the attached drawings in which:

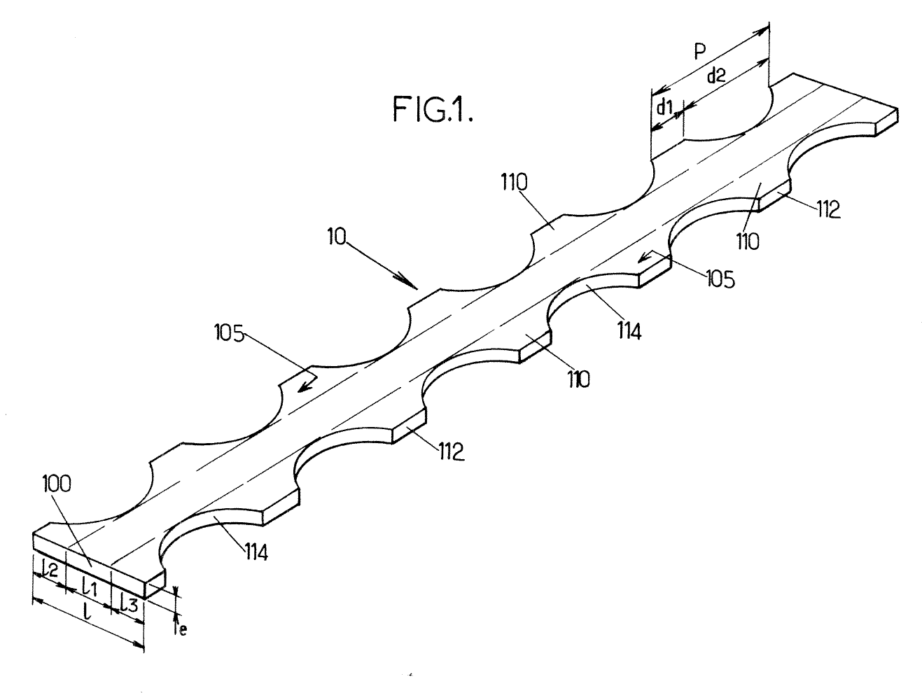

FIG. 1 is a schematic perspective view of a first embodiment of a flexible reinforcing strip according to the invention;

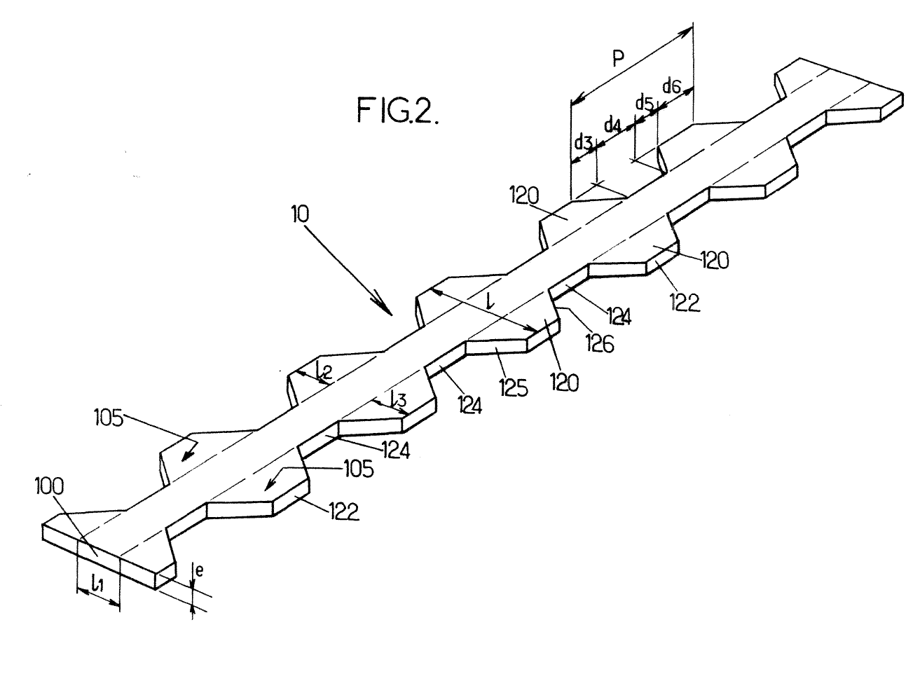

FIG. 2 is a schematic perspective view of a second embodiment of a flexible reinforcing strip according to the invention;

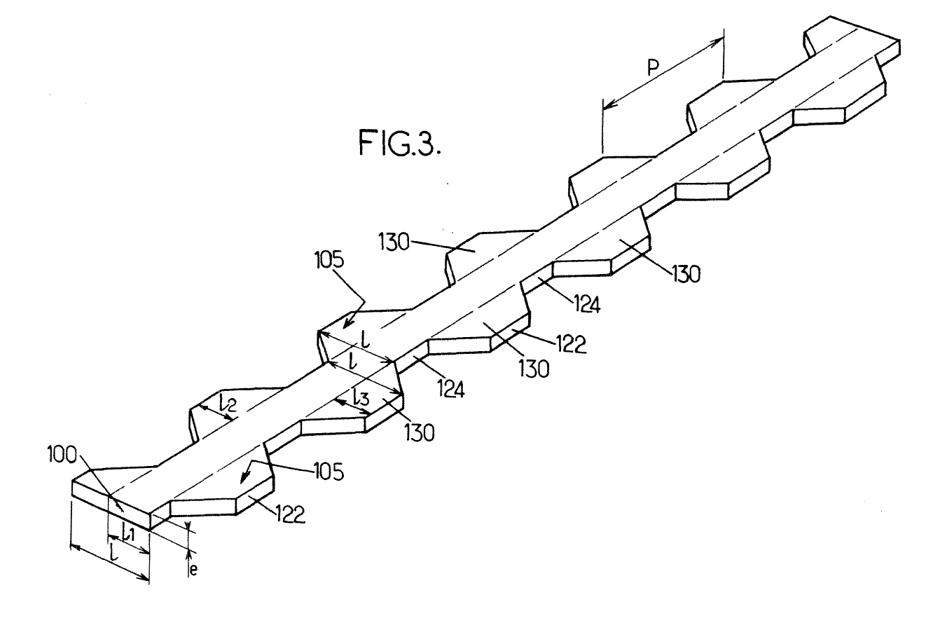

FIG. 3 is a schematic perspective view of a third embodiment of a flexible reinforcing strip according to the invention;

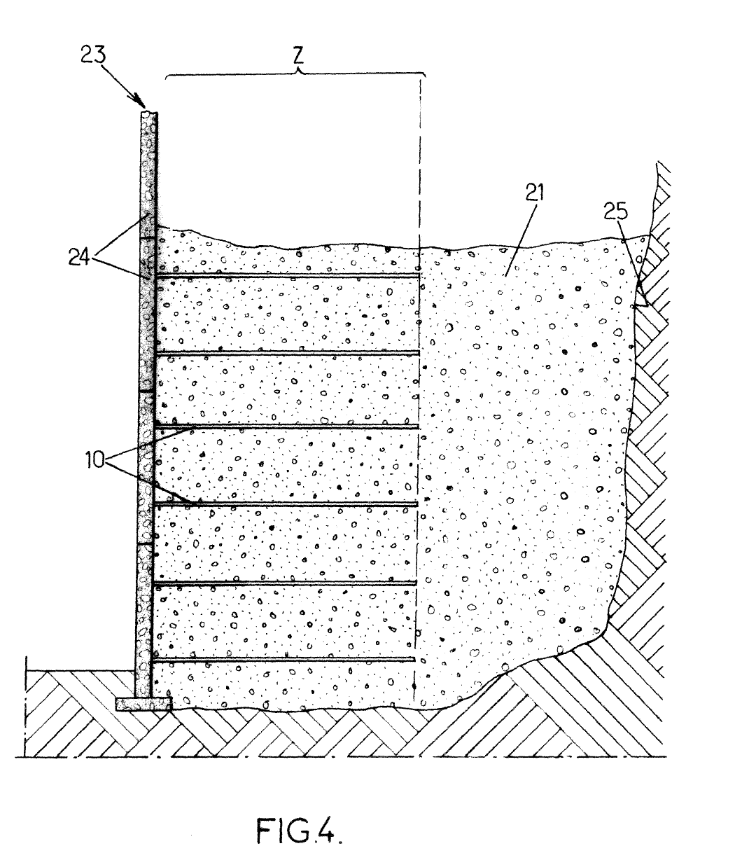

FIG. 4 is a schematic view in cross section of a reinforced soil construction according to the invention while it is in the process of being built.

For clarity, the various components depicted in the figures are not necessarily drawn to scale. In these figures, identical references correspond to elements that are identical.

FIG. 1 depicts a perspective view of a first embodiment of a flexible stabilizing strip (10) according to the invention.

The polymer matrix is, for example, based on polyethylene, polypropylene, PVC.

The fibres are preferably polymer fibres, for example based on polyester, on polyamide or on polyolefin. Metal fibres or natural fibres, for example those based on hemp may supplement the polymer fibres. For preference, the polymer fibres are continuous fibres.

The stabilizing strip 10 is of a thickness e that is substantially constant across the entire width and along the longitudinal axis. It is made up of a central portion 100 which runs longitudinally to withstand tensile forces and two symmetric lateral portions 105, situated one on each side of the central portion 100. The lateral portions 105 each comprise a plurality of segments 110 arranged uniformly along the longitudinal axis. Each segment 110 comprises a straight part 112 and two curved parts 114 which connect the ends of the straight part 112 to a zero-width lateral portion region.

The parts 114 depicted here are circular arcs. The width l₁ of the central portion 100 is constant along the longitudinal axis and the width of each of the lateral portions 105 varies continuously between 0 and l₂, l₃ where l₂, l₃ correspond to the maximum width of the segments in the region corresponding to the straight part 112. According to one embodiment, l₂ is equal to l₃. The maximum width of the flexible reinforcing strip is l where l=l₁+l₂+l₃ and its minimum width is l₁.

The segments 110 are distributed along the longitudinal axis with a constant spacing P, where P=d₁+d₂ with d₁ corresponding to the length of a straight part 112 and d₂ corresponding to the distance between two consecutive ends of two consecutive straight parts 112.

FIG. 2 depicts a perspective view of another embodiment of a flexible stabilizing strip according to the invention in which a different shape of segment has been chosen. The segments 110 of FIG. 1 are replaced here by segments 120. A segment 120 is a trapezium in which a straight part 122 runs parallel to the longitudinal axis and in which two straight parts 125, 126 connect the ends of the straight part 112 at an angle to a zero-width lateral portion region extending along the straight part 124.

The segments 120 are distributed along the longitudinal axis with a constant spacing P in which P=d₃+d₄+d₅+d₆ with d₃ and d₅ corresponding to the length of the projection onto the longitudinal axis of the angled parts 126 and 125, d₄ corresponding to the length of the straight part 124, and d₆ corresponding to the length of the straight part 122.

The stabilizing strips illustrated in FIGS. 1 and 2 can be obtained by cutting into the edges of a strip of width l in order to remove the material between the segments 110 or 120.

It is also possible to manufacture these strips using direct extrusion by varying the width of the extrusion head continuously from l₁ to l during the extrusion process.

FIG. 3 depicts an alternative form of embodiment a flexible stabilizing strip of FIG. 2 in which the segments 130, which have the same geometry as the segments 120, are not arranged symmetrically along the longitudinal axis but are offset from one another in the lengthwise direction. In one embodiment, the maximum widths l₂, l₃ of the lateral portions are identical and the variable-width lateral portions 105 are arranged in such a way that the width of the stabilizing strip is constant over its entire length.

A strip such as this can be obtained by cutting the edges of a strip of width l+l₂.

However, it is advantageous to produce such a strip by direct extrusion by moving a constant-width extrusion head back and forth during the extrusion process in order to form the segments 130.

The invention also relates to a method of building a reinforced soil construction.

FIG. 4 illustrates such a method. A compacted backfill 21, in which the stabilizing strips according to the invention 10 are distributed, is delimited across the frontal side of the construction by a facing 23 built by juxtaposing prefabricated elements 24, and is delimited on the rear side by the land 25.

To give the construction some cohesion, the stabilizing strips 10 may be connected to the facing elements 24 and may extend into the backfill 21 over a certain distance. These stabilizing strips 10 play a part in reinforcing the soil that lies in a reinforced region Z behind the facing 23.

In this reinforced region Z, the backfill material 21 is very strong because it is reinforced by the stabilizing strips 10. It is thus able to sustain the shear stresses applied to it as a result of the tensile forces experienced by the stabilizing strips 10. This reinforced region Z naturally has to be thick enough to be able to hold the facing 23 sufficiently in place.

Simply connecting the stabilizing strips to the backs of the facing elements 24 thus allows the facing to be kept pressed against the backfill of which there may be a vast volume.

In the example configuration of a construction which is illustrated in FIG. 4, the stabilizing strips 10 are positioned in superposed horizontal planes that alternate over the height of the construction.

In order to erect the construction shown in FIG. 4 one procedure may be as follows:

a) fitting some of the facing elements 24 so as to be able thereafter to bring in some backfill material up to a certain height. In a known way, the building up and positioning of the facing elements may be made easier by assembly components positioned between them;

b) installing stabilizing strips 10 in the backfill already present, applying light tension to them;

c) bringing in backfill material on top of the course of stabilizing strips 10 that has just been installed, up to the next level of stabilizing strips 10 on the rear side of the facing elements 24. This backfill material is compacted progressively as it is introduced;

d) repeating steps a) to c) until the uppermost level of backfill is reached.

It should be noted that numerous alternative forms may be applied to the abovementioned structure and to the method of achieving it.

It is also possible to use the flexible stabilizing strips according to the invention by securing them to wall 25 of the land by attaching them to the said wall, for example using hooks, rings nailed into the wall 25 or any other means known to those skilled in the art.

The invention is not restricted to these types of embodiment and is to be interpreted nonlimitingly, encompassing any equivalent embodiment.

1. A flexible stabilizing strip of substantially constant thickness e, intended to be used in reinforced soil constructions, comprising:
a central portion running longitudinally in order to withstand tensile forces, and
at least one variable-width lateral portion comprising a plurality of segments arranged in a continuity of material along the central portion.

2. The flexible stabilizing strip according to claim 1, wherein the central portion essentially consists of a fibre-reinforced polymer matrix.

3. The flexible stabilizing strip according to claim 2, wherein the variable-width lateral portion contains no fibres.

4. The flexible stabilizing strip according to claim 1, wherein a variable-width lateral portion lies on each side of the central portion.

5. The flexible stabilizing strip according to claim 1, wherein each segment of the variable-width lateral portion has a maximum width (l₂, l₃) less than or equal to the width (l₁) of the portion for withstanding tensile forces.

6. The flexible stabilizing strip according to claim 1, wherein the variable-width lateral portion segments are in the shape of a parallelepiped, for example of a trapezium.

7. The flexible stabilizing strip according to claim 1, wherein the variable-width lateral portion segments have a triangular shape.

8. The flexible stabilizing strip according to a claim 1, wherein the variable-width lateral portion segments have a shape comprising curved parts that connect the tensile-force-withstanding central portion to straight parts that are parallel to the central portion.

9. The flexible stabilizing strip according to claim 1, wherein the variable-width lateral portion segments extend over 20 to 80% of the length of the central portion

10. A reel of flexible stabilizing strip comprising a core around which a flexible stabilizing strip according to claims 1 is wound.

11. A method of manufacturing a flexible stabilizing strip according to claim 1, in which a flexible strip of substantially constant thickness e and width, particularly one obtained by extrusion, is sourced, and in which segments of material are cut away at least along one longitudinal edge to form a plurality of segments.

12. A method of manufacturing a flexible stabilizing strip according to claim 1 in which an extrudable material is extruded through an extrusion head in substantially the shape of a rectangle of which the shortest dimension corresponds to the desired thickness e of the said flexible stabilizing strip and the longest dimension can vary so as to vary the cross section of the said extrusion head during extrusion in order to form a plurality of segments.

13. A method of manufacturing a flexible stabilizing strip according to claim 1, in which an extrudable material is extruded through an extrusion head in substantially the shape of a rectangle of which the shortest dimension corresponds to the desired thickness e of the said flexible stabilizing strip and the longest dimension corresponds to its maximum width l, and in which the said extrusion head is moved back and forth in the direction of its longest dimension during the extrusion in order to form a plurality of segments.

14. The method of manufacturing a flexible stabilizing strip according to claim 12, wherein the extrudable material is a polymer matrix into which continuous fibres are inserted, in which the said continuous fibres are kept under tension during the extrusion process in order to reinforce that portion of the flexible stabilizing strip that runs longitudinally so as to withstand tensile forces.

15. A method of manufacturing a flexible stabilizing strip according to claim 1, wherein an extrudable material is extruded through an extrusion head in substantially the shape of a rectangle of which the shortest dimension corresponds to the desired thickness of the flexible stabilizing strip and the longest dimension corresponds to its central portion width and in which lateral segments are attached, for example by stitching, welding or bonding.

16. A method of manufacturing a flexible stabilizing strip according to claim 1, wherein an extrudable material is extruded to form the central portion of the reinforcing strip that is then placed in a mould, in which extrudable material is added in such a way as to form and attach, for example by welding, the lateral segments.

17. A method of manufacturing a flexible stabilizing strip according to claim 1, wherein an extrudable material is extruded through an extrusion head in substantially the shape of a rectangle of which the shortest dimension corresponds to the desired thickness of the flexible stabilizing strip and the longest dimension corresponds to its maximum width, and in which the material thus extruded passes through a sizing jig in substantially the shape of a rectangle of which the shortest dimension corresponds to the desired thickness of the flexible stabilizing strip and the longest dimension corresponds to its maximum width and in which the said sizing jig is moved back and forth in the direction of the longest dimension as the extruded material passes through the sizing jig so as to form a plurality of segments.

18. A reinforced soil construction comprising at least one stabilizing strip according to claim 1.

19. A method of building a reinforced soil construction in which a facing is laid across a frontal face of the construction, delimiting a volume that is to be backfilled, reinforcements are positioned in a region of the said volume, backfill material is brought into the said volume and the backfill material is compacted, wherein the reinforcements comprise at least one stabilizing strip according to claim 1.

20. The method of building according to claim 19, wherein the step in which the reinforcements are positioned comprises a step of unrolling the said reinforcements from a reel according to claim 10.
